(19) United States
(12) Patent Application Publication
(10) Pub. No.: US 2025/0128940 A1
(43) Pub. Date: Apr. 24, 2025

(54) HYDROCARBON PYROLYSIS SYSTEM AND METHOD

(71) Applicant: ONESIX ENERGY, INC., Detroit, MI (US)

(72) Inventor: Daniel Darga, Waterford Township, MI (US)

(21) Appl. No.: 18/921,738

(22) Filed: Oct. 21, 2024

Related U.S. Application Data
(60) Provisional application No. 63/591,800, filed on Oct. 20, 2023.

(51) Int. Cl. C01B 3/24; B01J 6/00

(52) U.S. Cl. CPC C01B 3/24; B01J 6/008; C01B 2203/0272; C01B 2203/0822; C01B 2203/1241

(57) ABSTRACT

A hydrocarbon pyrolysis system and associated method can include a pyrolysis chamber and a quenching chamber. The pyrolysis chamber can include a first inlet, a second inlet, and a third inlet. The first inlet can be configured to receive hydrocarbons, and the second inlet and third inlet can be configured to each receive oxygen and a fuel. The pyrolysis chamber can include a number of solid surfaces where a pyrolysis deposit can form. The solid surfaces can be disposed in close proximity to each other and configured to move relative to each other thereby removing the pyrolysis deposit from the surfaces. The relative motion between the solid surfaces can cause the pyrolysis deposit to be transported to the quenching chamber.

### CROSS-REFERENCE TO RELATED APPLICATIONS

This application claims the benefit of U.S. Provisional Application No. 63/591,800, filed on Oct. 20, 2023. The entire disclosure of the above application is hereby incorporated herein by reference.

### FIELD

The present technology relates to systems and methods for hydrocarbon pyrolysis and, more particularly, to a system and method for converting methane into carbon and hydrogen.

### INTRODUCTION

This section provides background information related to the present disclosure which is not necessarily prior art.

At a high level, the problem the present disclosure helps to solve is global warming. The release of greenhouse gases, such as carbon dioxide, into the atmosphere from the combustion of fossil fuels is causing the average global temperature to rise and, subsequently, local climates to change faster than life on the planet can efficiently adapt to the changes, leading to a multitude of distressing effects. As such, there is a need for industries reliant on the combustion of hydrocarbons to continue to sell their products with a vastly reduced environmental impact. One industry is that of hydrogen production. Used in many industries as process gas, and having great potential as a clean energy source, it is also nearly absent in nature by itself. Nearly all the hydrogen found in nature is chemically bonded to other elements, such as carbon and oxygen in the examples of methane and water. The process of producing hydrogen today is almost entirely the product of Steam Methane Reformation (SMR), which produces 11 kilograms of carbon dioxide for every kilogram of hydrogen. Alternatively, water can be electrolyzed to produce clean hydrogen, but it is extremely energy intensive, and it consumes fresh water, an increasingly valuable commodity. Hydrogen production today is the choice between inexpensive but dirty and clean but expensive.

An alternative approach has the potential for producing hydrogen that is both clean and inexpensive: hydrocarbon pyrolysis. Hydrocarbon pyrolysis is the process of splitting hydrocarbons at high temperatures into their elemental components. The pyrolysis of hydrocarbons, such as methane, is a chain of sequential chemical transformations that ultimately primarily results in the formation of hydrogen gas and solid carbon.

There are a few primary methods of hydrocarbon pyrolysis that are known. One method of hydrocarbon pyrolysis is known as catalytic decomposition. Catalytic decomposition involves the decomposition of hydrocarbons in a fluidized bed over a catalyst. The challenge to this approach is keeping the catalysis activated, as the carbon product tends to deposit on the catalyst, deactivating it. Process complexities of continuously regenerating the catalyst are required. Research and development in catalyst robustness often involves passing methane through molten catalytic metals, where the hydrogen bubbles out and the carbon is removed by skimming it off the surface of the liquid catalyst. These methods are overly complicated and quite expensive.

Another known method of hydrocarbon pyrolysis is non-catalytic and involves thermal decomposition. Thermal decomposition involves the processing of hydrocarbons under high temperatures without oxygen. This method requires entraining methane into a heated gas. Keeping the pyrolysis chamber and downstream passageways free of carbon build-up is managed by utilizing high velocities to keep the carbon moving through the pyrolysis chamber. The challenge to this approach is maintaining enough residence time for the transfer of sufficient heat to pyrolyze all the methane in the high velocity environment.

Alternatively, the entrainment gas can be heated to the point where it becomes a plasma. The plasma's very high temperature is utilized to ensure sufficient heat transfer during the short residence time. Whether achieved through large volumes or high temperatures, this approach is also prone to high costs and technical complexity.

There is a continuing need for a hydrocarbon pyrolysis system and method that efficiently and inexpensively converts hydrocarbons, such as methane, into hydrogen and carbon.

### SUMMARY

In concordance with the instant disclosure, a hydrocarbon pyrolysis system and method that efficiently and inexpensively converts hydrocarbons, such as methane, into hydrogen and carbon, has surprisingly been discovered.

The present technology includes articles of manufacture, systems, and processes that relate to hydrocarbon pyrolysis systems that efficiently and inexpensively convert hydrocarbons, such as methane, into elemental hydrogen and carbon.

In one embodiment, a hydrocarbon pyrolysis system can include a pyrolysis chamber, an outlet, and a quenching chamber. The pyrolysis chamber can include a first inlet and a second inlet. The first inlet can be configured to receive hydrocarbons. The second inlet can be configured to receive oxygen and a fuel. The pyrolysis chamber can further include a first solid surface and a second solid surface. One of the first solid surface and the second solid surface can be configured to move proximate to the other of the first solid surface and the second solid surface, thereby removing a pyrolysis deposit on one or both of the first solid surface and the second solid surface. The first solid surface can include a portion of a first auger. The first auger can include a combustion chamber and can be configured to receive oxygen and the fuel from the second inlet. The second solid surface can include a portion of an interior surface of the pyrolysis chamber. The outlet can be configured to receive hydrogen formed from the pyrolysis of hydrocarbon. The quenching chamber can be configured to receive the pyrolysis deposit from the pyrolysis chamber. The quenching chamber can include a funnel, a water inlet, and a drain hole.

In another embodiment, the pyrolysis chamber can further include a third solid surface and a third inlet. The first solid surface and the second solid surface can be configured to move proximate to the third solid surface, thereby removing a pyrolysis deposit on one or more of the first solid surface, the second solid surface, and the third solid surface.

The first solid surface can include a portion of a first auger. The first auger can include a first combustion chamber which can be configured to receive oxygen and fuel from the second inlet. The second solid surface can include a second auger. The second auger can include a second combustion chamber which can be configured to receive oxygen and fuel from the third inlet. The third solid surface can include an interior surface of the pyrolysis chamber. The first solid surface and the second solid surface can be configured to counter-rotate.

The first solid surface can be configured with a plurality of helical threads and the second solid surface can be configured with a plurality of helical threads. Each helical thread of the plurality of helical threads can include a substantially U-shaped cross-section.

The pyrolysis chamber can further include an outlet. The outlet can be configured to receive hydrogen formed from the pyrolysis of hydrocarbon. The quenching chamber can include a funnel, a water inlet, and a drain hole. The quenching chamber can be configured to receive the pyrolysis deposit and hydrogen from the pyrolysis chamber.

In a further embodiment, the first solid surface can include a rotating member and the second solid surface can include a stationary member. The rotating member can be configured to rotate. The rotating member and the stationary member can both include conical fins. The conical fins of the rotating member and the stationary member can be surfaces for the pyrolysis deposit to form on.

In certain embodiments, the rotating member can be one of a plurality of rotating members. Each rotating member of the plurality of rotating members can include a conical fin. The stationary member can be one of a plurality of stationary members. Each stationary member of the plurality of stationary members can include a conical fin. The conical fin of each rotating member of the plurality of rotating members and the conical fin of each stationary member of the plurality of stationary members can be arranged in an alternating stack. The conical fin of each rotating member can be configured to alternately approach and move across the conical fin of the stationary member disposed above it and below it in the alternating stack.

The pyrolysis chamber can include a combustion chamber. The combustion chamber can include an axle, a cam, and an exhaust port. The axle can be coupled to the combustion chamber. The cam can include an undulating surface.

In additional embodiments, a method of using a hydrocarbon pyrolysis system is provided. The method of using a hydrocarbon pyrolysis system can include the steps of feeding a predetermined amount of hydrocarbon into a first inlet and feeding a predetermined amount of oxygen and fuel into a second. The method can further include combusting the predetermined amount of oxygen and the fuel to produce thermal energy. The thermal energy produced can be applied to heat the predetermined amount of hydrocarbon to produce a pyrolysis deposit and hydrogen. The method can further include mechanically wiping or removing the pyrolysis deposit. The pyrolysis deposit can then be quenched to prevent recombination with hydrogen. The method can further include capturing products of pyrolysis.

Advantageously, and as described further herein, the hydrocarbon pyrolysis system employs a pyrolysis method that can help to avoid the complexities involved with keeping a catalyst activated as well as the extreme environments of the plasma approach. More specifically, the present disclosure features three key advantages. The first advantage is that it enables a pyrolysis method that produces the necessary heat via the combustion of hydrogen. The heat of combustion per unit mass of hydrogen is significantly greater than the heat required to pyrolyze methane. Therefore, only a fraction of the hydrogen produced in the pyrolysis process is required in the combustion process. Combusting hydrogen produces heat with 100% efficiency, and compared to the alternative of heating via electricity—and in particular, that produced by renewable sources—it results in a significant economic advantage.

The second advantage is that it provides a simple mechanism for managing the carbon product in a way that enables pyrolysis temperatures low enough to be managed by readily available and inexpensive materials without active cooling, and production of significant quantities of both carbon and hydrogen.

The third advantage is that it enables independent control of the residence time in the high-temperature zone for both the hydrogen and carbon, allowing for the optimization of the operating process in order to maximize the throughput of hydrogen and the quality of the carbon independently.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram detailing the hydrogen pyrolysis system, according to an embodiment of the present disclosure; and

FIG. 2 is a top perspective view of the hydrocarbon pyrolysis system, according to an embodiment of the present disclosure;

FIG. 3 is a cross-sectional depiction of a first inlet, a first auger, and a first combustion chamber adjacent a second auger of the hydrocarbon pyrolysis system, according to an embodiment shown in FIG. 1;

FIG. 4 is a cross-sectional depiction of the first auger and the second auger of the hydrocarbon pyrolysis system, according to an embodiment shown in FIG. 1;

FIG. 5 is a top perspective view of the first auger and the second auger of the hydrocarbon pyrolysis system, according to an embodiment shown in FIG. 1;

FIG. 6 is a cross-sectional depiction of a quenching chamber of the hydrocarbon pyrolysis system, according to an embodiment shown in FIG. 1;

FIG. 7 is a cross-sectional depiction of a hydrocarbon pyrolysis system, according to another embodiment of the present disclosure;

FIG. 8 is a cross-sectional depiction of the hydrocarbon pyrolysis system, according to an embodiment shown in FIG. 7;

FIG. 9 is a cross-sectional depiction of a plurality of helical threads with a substantially U-shaped cross-section of the hydrocarbon pyrolysis system, according to an embodiment in FIG. 7;

FIG. 10 is a cross-sectional depiction of a hydrocarbon pyrolysis chamber, according to another embodiment of the present disclosure;

FIG. 11 is an exploded cross-sectional depiction of a hydrocarbon pyrolysis chamber of the hydrocarbon pyrolysis system, according to an embodiment in FIG. 10;

FIG. 12 is a cross-sectional depiction of a hydrocarbon pyrolysis chamber of the hydrocarbon pyrolysis system, according to an embodiment in FIG. 10;

FIG. 13 is a bottom perspective view of a cam and an axle of a hydrocarbon pyrolysis chamber of the hydrocarbon pyrolysis system, according to an embodiment in FIG. 10;

FIG. 14 is a flow chart illustrating a method of using a hydrocarbon pyrolysis system, according to an embodiment of the present disclosure; and

FIG. 15 is a flow chart continuing from FIG. 14 and further illustrating the method of using the hydrocarbon pyrolysis system, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

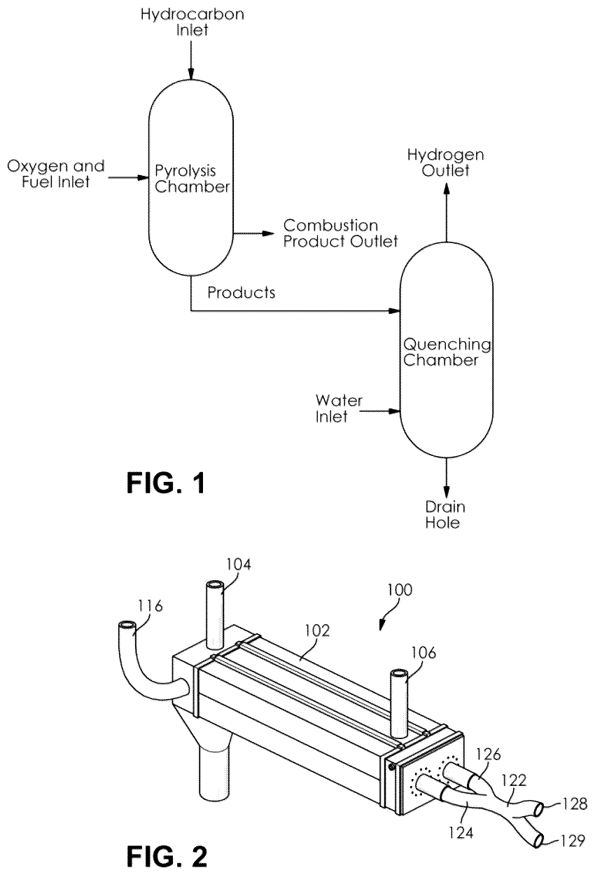

As generally shown in FIG. 1, the present technology improves hydrocarbon pyrolysis systems by addressing certain challenges in the design and functionality of methane pyrolysis systems. Aspects of the present technology allow for the efficient and inexpensive conversion of hydrocarbon, such as methane, into carbon and hydrogen.

Additionally, the present technology enables a hydrocarbon pyrolysis system that produces the necessary heat via the combustion of hydrogen. Combusting hydrogen produces heat with 100 percent efficiency and results in a significant economic advantage over other methods of producing heat.

The present technology also provides a simple and robust mechanism for managing the carbon product in a way that enables pyrolysis temperatures low enough to be managed by readily available and inexpensive materials without active cooling, and production of significant quantities of both carbon and hydrogen. The risk associated with process failure due to carbon depositing in deleterious locations is mitigated by providing surfaces for the carbon to deposit which can be continuously and mechanically cleaned.

Lastly, the present technology enables independent control of the residence time in the high-temperature zone for both the hydrogen and carbon, allowing for the optimization of the operating process in order to maximize the throughput of hydrogen and the quality of the carbon independently.

The hydrocarbon pyrolysis system can be configured to produce carbon and hydrogen through a thermal decomposition of hydrocarbon, such as methane. The process can begin by feeding a hydrocarbon, such as methane, through a first inlet into a pyrolysis chamber. Next, hydrogen and a fuel can be introduced through a second inlet into a combustion chamber, where the hydrogen and fuel can be ignited to produce heat. This heat can then be conducted through the combustion chamber and transferred to the pyrolysis chamber. As the temperature rises in the pyrolysis chamber, methane can decompose into a pyrolysis deposit (e.g. carbon) and hydrogen. The pyrolysis deposit can then be deposited onto any available surface of the pyrolysis chamber.

The pyrolysis chamber can include a first solid surface and a second solid surface. One of the first solid surface and the second solid surface can be configured to move proximate to the other of the first solid surface and the second solid surface. One of the first solid surface and the second solid surface can also be configured to directly contact the other of the first solid surface and the second solid surface. One of ordinary skill in the art can select a suitable separation between the first solid surface and the second solid surface to achieve the desired proximate movement within the present scope of the disclosure.

Over the course of operation, the pyrolysis deposit can build up to a sufficient thickness so that the pyrolysis deposit on the solid surfaces come into contact with each other. Through relative mechanical motion and the direct contact between the pyrolysis deposit on the first solid surface and the second solid surface, as will be described in further detail below, the carbon or pyrolysis deposit can be mechanically wiped off the solid surfaces allowing for more carbon or pyrolysis deposits to form.

During operation, the carbon or pyrolysis deposit can be transported via the relative mechanical motion of the first and second surface from a proximal end to a distal end of the pyrolysis chamber and then be transferred into a quenching chamber. The quenching chamber can be fed with water to quench the carbon or pyrolysis deposit and prevent an undesired recombination of the pyrolysis deposit (e.g. carbon) with hydrogen.

### EXAMPLES

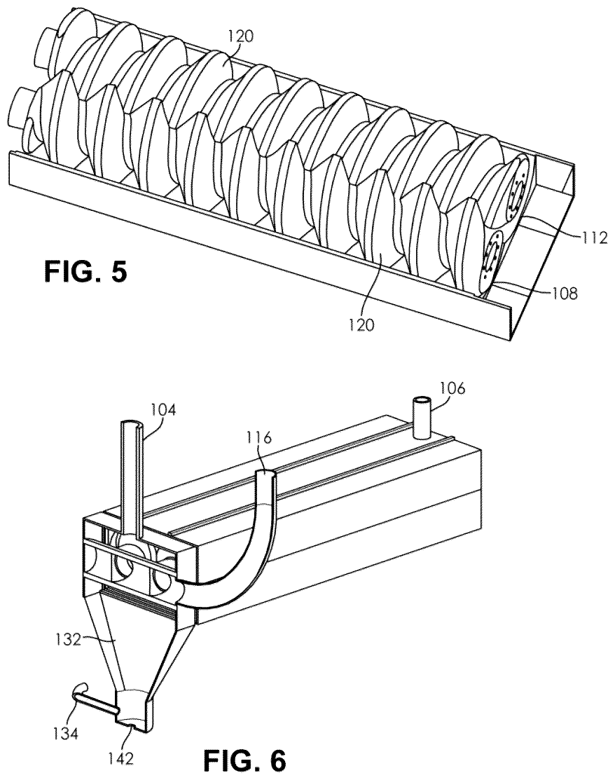

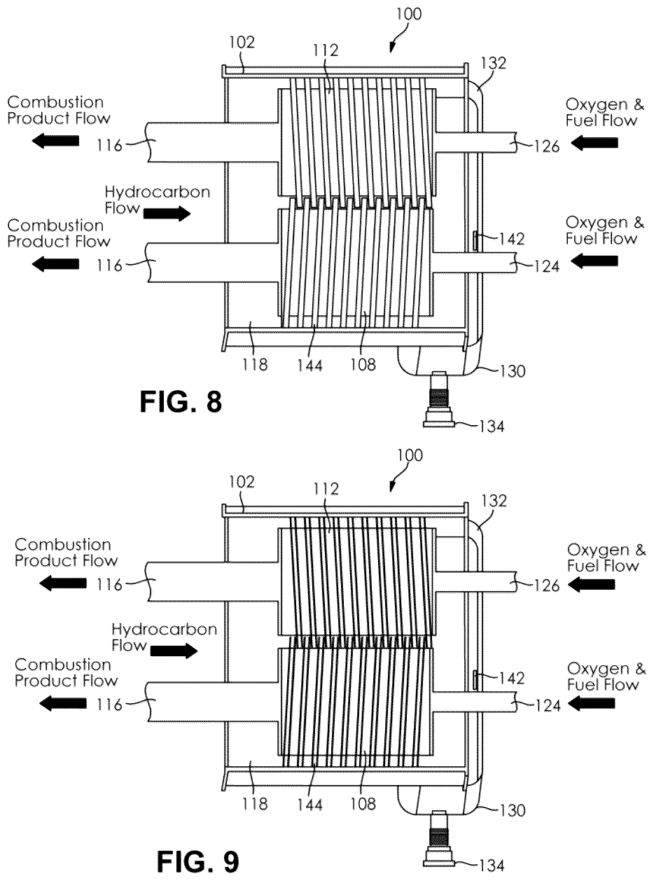

Example embodiments of the present technology are provided with reference to the several figures enclosed herewith. More specifically, the present technology relates to a hydrocarbon pyrolysis system 100 and a method 200 of using the hydrocarbon pyrolysis system, as illustrated generally in FIGS. 2-15.

With reference to FIGS. 2-6, the hydrocarbon pyrolysis system 100 can include a pyrolysis chamber 102. The pyrolysis chamber 102 can include a first inlet 104 and an outlet 106. The pyrolysis chamber 102 can include a second inlet 124 and a third inlet 126. The first inlet 104 can be disposed at the distal end of the pyrolysis chamber 102. The outlet 106, the second inlet 124 and the third inlet 126 can be disposed at a proximal end of the pyrolysis chamber 102.

The first inlet 104 can be configured to supply hydrocarbon to the pyrolysis chamber 102. As a non-limiting example, methane can be used as the hydrocarbon. It should be understood that one of ordinary skill in the art can select a suitable hydrocarbon for pyrolysis within the scope of the present disclosure.

The second inlet 124 and the third inlet 126 can be configured to receive oxygen and a fuel, such as hydrogen or methane. As a non-limiting example, oxygen can be acquired from a variety of sources, including air. One of ordinary skill in the art can select a suitable source for oxygen within the scope of the present disclosure.

In certain embodiments, the pyrolysis chamber 102 can include a first auger 108. The first auger 108 can include a first combustion chamber 110 disposed in an interior of the first auger 108. The first combustion chamber 110 can be configured to receive oxygen and fuel from the second inlet 124. The first auger 108 can be configured to receive hydrocarbon from the first inlet 104. The pyrolysis chamber 102 can further include a second auger 112. The second auger 112 can include a second combustion chamber 114 disposed in an interior of the second auger 112. The second combustion chamber 114 can be configured to receive oxygen and fuel from the third inlet 126. The second auger 112 can be configured to receive hydrocarbon from the first inlet 104.

Each of the first combustion chamber 110 and the second combustion chamber 114 can include an exhaust port 116. The pyrolysis chamber 102 can further include an interior surface 118 of the pyrolysis chamber 102. The oxygen and fuel can be ignited to produce heat. This heat can then be transferred to a pyrolysis chamber to heat the hydrocarbon. As the hydrocarbon increases in temperature, a decomposition of hydrocarbon can occur. The decomposition of hydrocarbon, specifically methane, can result in the formation of a pyrolysis deposit (e.g. carbon) and hydrogen. The pyrolysis deposit can form on the first auger 108, the second auger 112, and the interior surface 118 of the pyrolysis chamber 102.

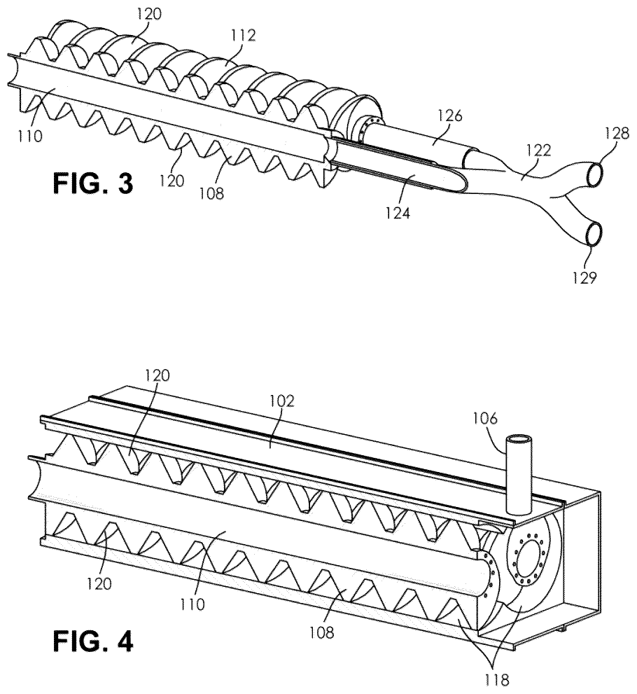

With reference to FIGS. 3-5, each of the first auger 108 and the second auger 112 can include a blade 120. Advantageously, each of the first auger 108 and the second auger 112 can be disposed such that the blades 120 of each of the first auger 108 and the second auger 112 can efficiently nest in one another. While nested, the first auger 108 and the second auger 112 can be configured to move proximate to one another. The first auger 108 and the second auger 112 can move in close proximity to one another without making contact. A spacing between the first auger 108 and the second auger 112 can be designed to minimize friction or interference, allowing for synchronized or independent rotation. This configuration ensures efficient operation while reducing the risk of mechanical wear or damage that could occur from direct contact.

In some embodiments, the first auger 108 and the second auger 112 can also be configured to directly contact each other and contact the interior surface 118 of the pyrolysis chamber 102. The first auger 108 and the second auger 112 can be configured to rotate. The first auger 108 and the second auger 112 can be configured to rotate in the same direction and in opposite directions. One of ordinary skill in the art can select a suitable direction of rotation with the scope of the present disclosure.

In operation, as the first auger 108 and the second auger 112 rotate, the relative motion between the first auger 108, the second auger 112, and the interior surface 118 of the pyrolysis chamber 102 can mechanically wipe or remove the pyrolysis deposit on one or more of the first auger 108, the second auger 112, and the interior surface 118 of the pyrolysis chamber 102. The pyrolysis deposit can then be transported along a length of the pyrolysis chamber 102 as the first auger 108 and the second auger 112 rotate.

Advantageously, the first auger 108, the second auger 112, and the interior surface 118 of the pyrolysis chamber 102 can be configured with tight tolerances to mitigate hydrocarbon passing between the first auger 108, the second auger 112, and the interior surface 118 of the pyrolysis chamber 102 to maximize a residence time of the hydrocarbon in the pyrolysis chamber 102. This maximized residence time can allow the pyrolysis deposit to coalesce into particles large enough to be influenced by gravity and collect on any available surface, namely the first auger 108, the second auger 112, and the interior surface 118 of the pyrolysis chamber 102. The residence time of the hydrocarbon can be a function of the length of the first auger 108 and the second auger 112, and a speed of the rotation of the first auger 108 and the second auger 112.

With reference to FIGS. 2 and 3, the second inlet 124 and the third inlet 126 can be configured to receive oxygen and the fuel. If oxygen and the fuel are sourced separately, a first pipe 128 can be configured to receive oxygen and a second pipe 129 can be configured to receive fuel, which both can be configured to merge into a mixing chamber 122. The merging of the first pipe 128 and the second pipe 129 can facilitate proper mixing of oxygen and the fuel before the oxygen and the fuel is distributed into the second inlet 124 and the third inlet 126. The diameter in both the second inlet 124 and third inlet 126 can be reduced to ensure that a flow rate of oxygen and the fuel can exceed a flame propagation speed, thereby preventing flashback. One of ordinary skill in the art can select a suitable set of diameters within the scope of the present disclosure.

Referring now to FIG. 6, the pyrolysis system 100 can further include a quenching chamber 130. The quenching chamber 130 can be disposed at a distal end of the pyrolysis chamber 102. The quenching chamber 130 can be configured to receive the pyrolysis deposit and hydrogen from the distal end of the pyrolysis chamber 102. The quenching chamber 130 can include a funnel 132, a water inlet 134, and a drain hole 142. The quenching chamber 130 can be designed to prevent an undesired recombination of the pyrolysis deposit (e.g. carbon) with hydrogen.

During operation, as the pyrolysis deposit moves towards the distal end of the pyrolysis chamber 102, the pyrolysis deposit can fall into the funnel 132. The funnel 132 can direct the pyrolysis deposit into a pool of water formed by the water inlet 134. The pool of water can immediately quench the pyrolysis deposit and can prevent an undesired recombination of the pyrolysis deposit with hydrogen. The water from the water inlet 134 and the pyrolysis deposit can then flow through the drain hole 142 for later separation and collection of the pyrolysis deposit. Hydrogen formed from the decomposition of hydrocarbon (e.g. methane) from the pyrolysis chamber 102 can flow through the outlet 106.

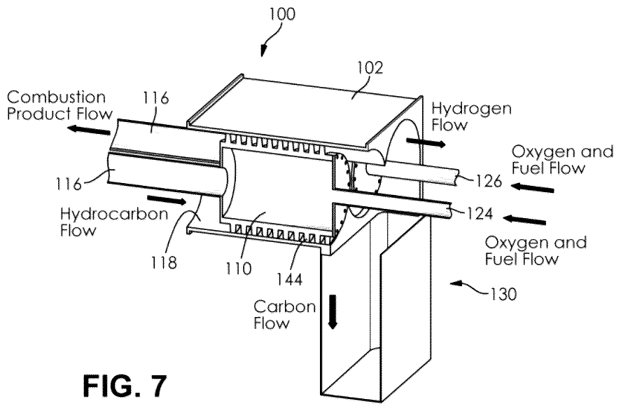

Turning to FIGS. 7-9, in some embodiments, the first auger 108 and second auger 112 can instead include helical threads 144. With particular reference to FIG. 9, the helical threads 144 can have a substantially U-shaped cross-section. This U-shaped cross-section can enable the hydrocarbon to pass between the first auger 108 and the second auger 112 at a flowrate faster or slower than the rotation of the first auger 108 and the second auger 112. Advantageously, this can optimize throughput and yield of hydrogen production, while also optimizing the time that the hydrocarbon spends in the pyrolysis chamber 102.

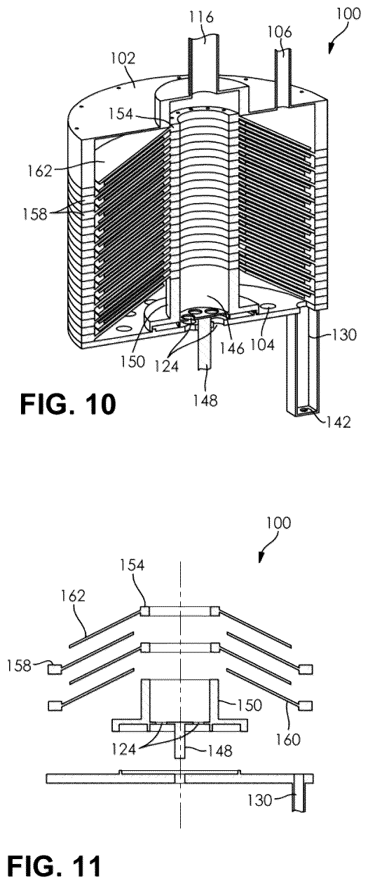

Turning now to FIGS. 10-13, a hydrocarbon pyrolysis system 100 according to another embodiment of the present disclosure is shown. The hydrocarbon pyrolysis system 100 can include a pyrolysis chamber 102. The pyrolysis chamber 102 can include a first inlet 104 and a second inlet 124. The first inlet 104 and the second inlet 124 can be disposed at a proximal end of the pyrolysis chamber 102.

The first inlet 104 can be configured to supply hydrocarbon to the pyrolysis chamber 102. As a further non-limiting example, methane can be used as the hydrocarbon. It should be understood that one of ordinary skill in the art can select a suitable hydrocarbon for pyrolysis within the scope of the present disclosure.

The second inlet 124 can be configured to receive oxygen and a fuel, such as hydrogen or methane. As a non-limiting example, oxygen can be acquired from a variety of sources, including air. One of ordinary skill in the art can select a suitable source for oxygen within the scope of the present disclosure.

The pyrolysis chamber 102 can further include an outlet 106 disposed at a distal end of the pyrolysis chamber 102. The outlet 106 can be configured to allow hydrogen formed from the decomposition of hydrocarbon to escape.

With reference to FIG. 10, the pyrolysis chamber 102 can include a combustion chamber 146 disposed in an interior of the pyrolysis chamber 102. The combustion chamber 146 can be configured to receive oxygen and fuel from the second inlet 124. The oxygen and fuel can be ignited to produce heat. A size of the second inlet 124 can be selected to produce a flow velocity that exceeds a flame propagation speed, thereby preventing flashback. The heat can then be conducted to a pyrolysis chamber 102 to heat the hydrocarbon. As the hydrocarbon increases in temperature, a decomposition of hydrocarbon can occur. The decomposition of hydrocarbon, specifically methane, can result in the formation of a pyrolysis deposit (e.g. carbon) and hydrogen.

With reference to FIGS. 10, 11, and 13, the combustion chamber 146 can include an axle 148, a cam 150, and an exhaust port 116. The axle 148 can be coupled to the cam 150 or the combustion chamber 146 directly. The cam 150 can be coupled to the combustion chamber 146. The cam 150 can include an undulating surface 152 and a bearing. The bearing can be disposed between the proximal end of the pyrolysis chamber 102 and the cam 150. The bearing can allow the cam 150 and the combustion chamber 146 to efficiently rotate, in operation.

The pyrolysis chamber 102 can further include a rotating member 154 having a conical fin 162, and a stationary member 158 having a conical fin 160. The conical fin 160 of the stationary member 158 can include a face. A surface of the conical fin 162 of the rotating member 154 and a surface of the conical fin 160 of the stationary member 158 can be surfaces for the pyrolysis deposit to form on. The rotating member 154 can be coupled to an exterior surface of the combustion chamber 146. The stationary member 158 can be coupled to an interior surface of the pyrolysis chamber 102. During operation, the external mechanical force can be applied to the axle 148 causing it to rotate. This, in turn, can rotate the cam 150, the combustion chamber 146, and the rotating member 154.

In certain embodiments, and with reference to FIGS. 10 and 11, the rotating member 154 can be one of a plurality of rotating members. Each rotating member 154 of the plurality of rotating members can include a conical fin 162. The stationary member 158 can be one of a plurality of stationary members. Each stationary member 158 of the plurality of stationary members can include a conical fin 160 having a face. The conical fin 162 of each rotating member 154 of the plurality of rotating members and the conical fin 160 of each stationary member 158 of the plurality of stationary members can be arranged in an alternating stack. The conical fin 162 of each rotating member 154 can be configured to alternately approach and move across the face of the conical fin 160 of the stationary member 158 disposed above it and below it in the alternating stack.

With continued reference to FIGS. 10 and 11, during a portion of rotation, as the cam 150 rotates over the bearing, a low point of the undulating surface 152 can cause the combustion chamber 146 and the conical fin 162 of each rotating member 154 of the plurality of rotating members to move vertically toward the distal end of the pyrolysis chamber 102. This portion of rotation can cause the conical fin 162 of each rotating member 154 of the plurality of rotating members to approach and move across the face of the conical fin 160 of each stationary member 158 of the plurality of stationary members disposed above in the alternating stack.

As the cam 150 continues to rotate during another portion of rotation, a high point of the undulating surface 152 can cause the combustion chamber 146 and the conical fin 162 of each rotating member 154 of the plurality of rotating members to move vertically toward the proximal end of the pyrolysis chamber 102. This portion of rotation can cause the conical fin 162 of each rotating member 154 of the plurality of rotating members to approach and move across the face of the conical fin 160 of each stationary member 158 of the plurality of stationary members disposed below in the alternating stack. Both portions of rotation and vertical motion of the conical fin 162 of the rotating member 154 can mechanically wipe or remove the pyrolysis deposit from the conical fin 162 of the rotating member 154 and the conical fin 160 of the stationary member 158.

With reference to FIGS. 10 and 11, the conical fins 160 of the stationary member 158 and the conical fins 162 of the rotating member 154 can both be configured at an angle relative to a rotational axis of motion. Advantageously, angling the conical fins 160 of the stationary members 158 and the conical fins 162 of the rotating members 154 can allow the pyrolysis system 100 to benefit from a force of gravity. One of ordinary skill in the art can select a suitable angle for the conical fins 160 of the stationary members 158 and the conical fins 162 of the rotating members 154 within the scope of the present disclosure.

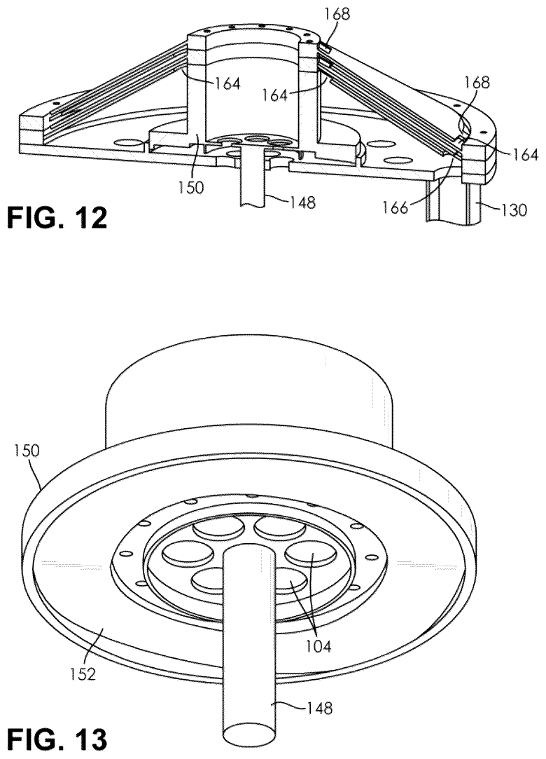

Turning to FIG. 12, the conical fins 162 of the rotating members 154 can each be configured with a gap 164. The gap 164 can allow for hydrocarbon to flow from the proximal end to the distal end of the pyrolysis chamber 102. The gap 164 can also allow the pyrolysis deposit to fall to onto the conical fins 160 of the stationary members 158 immediately beneath the gap 164 due to the force of gravity.

Additionally, the conical fins 160 of the stationary members 158 can each be configured with an aperture 166 that can also allow for hydrocarbon to flow from the proximal end to the distal end of the pyrolysis chamber 102. The aperture 166 can allow for the pyrolysis deposit to fall onto the conical fins 162 of the rotating members 154 below. The conical fins 162 of the rotating members 154 can further include an extension 168. The extension 168 can be configured to sweep any accumulated pyrolysis deposit into the aperture 166 of the conical fins 160 of the stationary members 158.

During operation, the relative motion between the conical fins 160 of the stationary members 158 and the conical fins 162 of the rotating members 154 can cause the pyrolysis deposit to be mechanically wiped or removed from the conical fins 160 of the stationary members 158 and the conical fins 162 of the rotating members 154. After the mechanical wiping or removal of the pyrolysis deposit, the pyrolysis deposit can move toward the proximal end of the pyrolysis chamber 102 through the gap 164 of the conical fins 162 of the rotating members 154 and apertures 166 of the conical fins 160 of the stationary members 158. The conical fins 162 of the rotating members 154 and the conical fins 160 of the stationary members 158 can be arranged in an alternating stack to avoid having all the apertures 166 from aligning above each other, thereby avoiding a short-circuit for the hydrocarbons to flow from the proximal end to the distal end.

With reference to FIG. 10, the pyrolysis system 100 can further include a quenching chamber 130. The quenching chamber 130 can be disposed at the proximal end of the pyrolysis chamber 102. The quenching chamber 130 can be configured to receive the pyrolysis deposit from the proximal end of the pyrolysis chamber 102. The quenching chamber 130 can include a water inlet 134 and a drain hole 142. The quenching chamber 130 can be designed to prevent an undesired recombination of the pyrolysis deposit with hydrogen.

During operation, as the pyrolysis deposit moves towards the proximate end of the pyrolysis chamber 102, it can fall into a pool of water formed by the water inlet 134. The water can immediately quench the pyrolysis deposit and prevent an undesired recombination of the pyrolysis deposit with hydrogen. The water from the water inlet 134 and the pyrolysis deposit can then flow through the drain hole 142 for later separation and collection of the pyrolysis deposit.

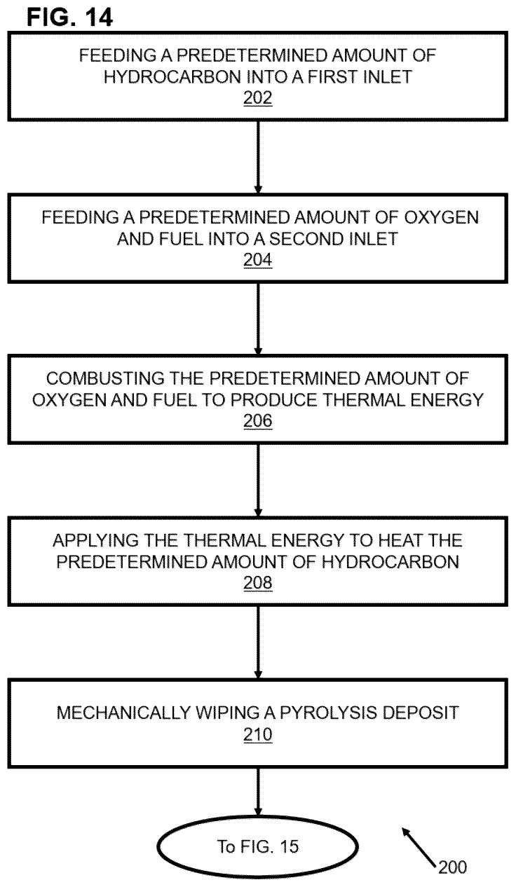

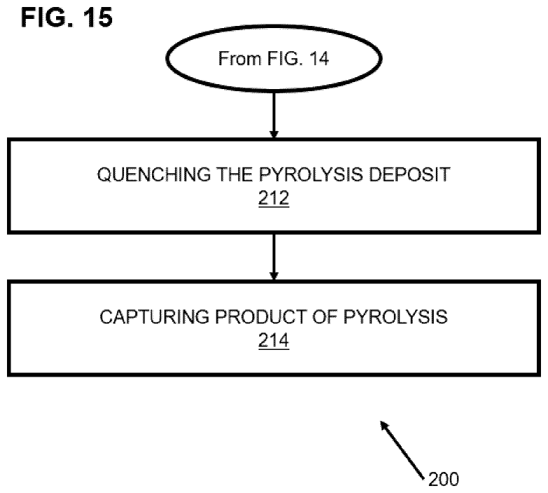

With reference to FIGS. 14 and 15, the present disclosure also contemplates a method 200 of using the hydrocarbon pyrolysis system 100. In a first step 202, a predetermined amount of hydrocarbon can be fed into a first inlet 104. In a second step 204, a predetermined amount of oxygen and fuel can be fed into a second inlet 124 and a third inlet 126. The predetermined amount of oxygen and fuel can be combusted to produce thermal energy (heat) in a third step 206. In a fourth step 208, the thermal energy produced by the combustion of oxygen and fuel can be transferred to the predetermined amount of hydrocarbon. The application of the thermal energy to the predetermined amount of hydrocarbon can produce a product of pyrolysis, including a pyrolysis deposit and hydrogen. In a fifth step 210, the pyrolysis deposit can be mechanically wiped. The pyrolysis deposit can then be quenched in a sixth step 212. In a final step, the products of pyrolysis can be captured.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A hydrocarbon pyrolysis system comprising:
a pyrolysis chamber including:
a first inlet configured to receive hydrocarbon,
a second inlet configured to receive oxygen and fuel,
a first solid surface and a second solid surface, wherein one of the first solid surface and the second solid surface is configured to move proximate to the other of the first solid surface and the second solid surface, thereby removing a pyrolysis deposit on one or both of the first solid surface and the second solid surface, and
an outlet; and
a quenching chamber coupled to the outlet.

2. The hydrocarbon pyrolysis system of claim 1, wherein the first solid surface comprises a portion of a first auger and the second solid surface comprises a portion of an interior surface of the pyrolysis chamber.

3. The hydrocarbon pyrolysis system of claim 2, wherein the first auger includes a combustion chamber.

4. The hydrocarbon pyrolysis system of claim 1, wherein:
the pyrolysis chamber further includes a third inlet configured to receive oxygen and fuel,
the first solid surface comprises a portion of a first auger,
the second solid surface comprises a portion of a second auger, and
an interior surface of the pyrolysis chamber includes a third solid surface, the first solid surface and the second solid surface configured to move proximate to the third solid surface, thereby removing a pyrolysis deposit on one or more of the first solid surface, the second solid surface, and the third solid surface.

5. The hydrocarbon pyrolysis system of claim 4, wherein the first auger includes a first combustion chamber configured to receive the oxygen and the fuel from the second inlet, and the second auger includes a second combustion chamber configured to receive the oxygen and the fuel from the third inlet.

6. The hydrocarbon pyrolysis system of claim 4, wherein the first auger and the second auger are configured to counter rotate.

7. The hydrocarbon pyrolysis system of claim 4, wherein the first solid surface is configured with a plurality of helical threads, and the second solid surface is configured with a plurality of helical threads.

8. The hydrocarbon pyrolysis system of claim 7, wherein each helical thread of the plurality of helical threads has a substantially U-shaped cross-section.

9. The hydrocarbon pyrolysis system of claim 1, wherein the quenching chamber includes a funnel, a water inlet, and a drain hole.

10. The hydrocarbon pyrolysis system of claim 1, wherein the first solid surface comprises a rotating member and the second solid surface comprises a stationary member.

11. The hydrocarbon pyrolysis system of claim 10, wherein the stationary member includes a conical fin, and the rotating member includes a conical fin configured to move across a face of the conical fin of the stationary member as the conical fin of the rotating member rotates.

12. The hydrocarbon pyrolysis system of claim 10, wherein the first solid surface comprises a plurality of rotating members, each rotating member of the plurality of rotating members includes a conical fin; and the second solid surface comprises a plurality of stationary members, each stationary member of the plurality of stationary members includes a conical fin.

13. The hydrocarbon pyrolysis system of claim 12, wherein the conical fin of each rotating member of the plurality of rotating members is configured to alternately approach and move across the conical fin of each stationary member of the plurality of stationary members during a portion of a rotation.

14. The hydrocarbon pyrolysis system of claim 1, wherein the pyrolysis chamber includes a combustion chamber.

15. The hydrocarbon pyrolysis system of claim 14, wherein the combustion chamber includes an axle, a cam, and an exhaust port.

16. The hydrocarbon pyrolysis system of claim 15, wherein the axle is coupled to the combustion chamber.

17. The hydrocarbon pyrolysis system of claim 15, wherein the cam includes an undulating surface.

18. The hydrocarbon pyrolysis system of claim 12, wherein the conical fin of each rotating member of the plurality of rotating members and the conical fin of each stationary member of the plurality of stationary members are configured at an angle relative to a rotational axis of motion.

19. The hydrocarbon pyrolysis system of claim 12, wherein the conical fin of each rotating member of the plurality of rotating members includes an extension, and the conical fin of each stationary member of the plurality of stationary members includes an aperture.

20. A method of using a hydrocarbon pyrolysis system, the method comprising steps of:
feeding a predetermined amount of hydrocarbon into a first inlet;
feeding a predetermined amount of oxygen and fuel into a second inlet;
combusting the predetermined amount of oxygen and fuel to produce thermal energy;
applying the thermal energy to heat the predetermined amount of hydrocarbon;
mechanically wiping a pyrolysis deposit;
quenching the pyrolysis deposit; and
capturing a product of pyrolysis.
